(19) United States
(12) Patent Application Publication
(10) Pub. No.: US 2003/0176247 A1
(43) Pub. Date: Sep. 18, 2003

(54) Human-powered drive system

(76) Inventor: Joseph Herbert Gottschalk, San Antonio, TX (US)

Correspondence Address: Joseph H. Gottschalk, 855 Pennystone Ave., San Antonio, TX, 78223-1925, US

(21) Appl. No.: 10/098,085

(22) Filed: Mar. 15, 2002

(51) Int. Cl. F16H 9/10; F16H 59/00

(52) U.S. Cl. 474/53; 474/83; 474/64

(57) ABSTRACT

This invention replaces the crank-and-chain drive system of the conventional bicycle. A flexible drive line is pulled directly away from the hip by a stirrup located at the “ball” of the foot and drives the rear-wheel hub by means of a cone-shaped spool with a spiral groove. Routing pulleys mounted to a sliding shifter provide drive-ratio variability by adding line to or removing line from the spools, thus utilizing spool segments of varying diameter. A tensioned rewind system enables each spool, when driving the hub, to rewind the other. Benefits of this system as compared to prior art include: (1) the fact that the machine itself, as opposed to the operator's leg, changes the leg's naturally linear motion to rotary; and (2) a smoother, more efficient means of drive-ratio variation with the added advantage of infinite variability within limits.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, ETC.

Not Applicable

### BACKGROUND OF THE INVENTION

The field of endeavor to which this invention pertains is the development of an improved human-powered drive system for applications including, but not limited to, bicycles. Problems with the prior art in this field include: (1) the inefficiency of the crank in converting linear extension of the leg into rotary motion; and (2) the bulky and crude process of drive-ratio variation through chain derailment.

### BRIEF SUMMARY OF THE INVENTION

This invention addresses the inefficiency of the crank by providing a linear path of travel for the leg with a stirrup to be pulled downward by the “ball” of the foot. The stirrup, in turn, pulls a flexible line which ultimately rotates the rear-wheel hub while unwinding from a spool attached thereto and to which the line's other end is fastened.

As a secondary objective, this invention also provides a more efficient means of drive-ratio variation by calling for the groove in the drive spool to follow a conical and spiral path around the spool such that its diameter varies from one end of the spool to the other, and by then adding line to or deleting line from the spool such that different segments of the groove are engaged by the portion of line actually driving the spool. This active segment varies according to the position of the shifter, which carries a set of drive-line routing pulleys.

### BRIEF DESCRIPTION OF THE SEVERAL VIEWS OF THE DRAWINGS

FIG. 1 (Schematic of system)

A: Stirrup to be engaged at “ball” of foot

B: Drive line

C: Initial drive pulley, to be located immediately above foot at top of stroke

D: Routing pulleys

E: Routing pulleys which are moveable by being mounted to a sliding shifter (motion of shifter indicated by arrows)

F: Drive spool, also shown in FIG. 2

FIG. 2

F: Side and end views of drive spool

FIG. 3

A: View of leg position at top of stroke

1. Center of hip joint

2. Center of knee joint

3. Center of ankle joint

4. Center of “ball” of foot

B: View of leg position at mid-stroke

1-4. Same as in A

C: View of leg at bottom of stroke

1-4. Same as in A

D: Initial drive pulley (cf. FIG. 1C)

E: Composite view of stroke comprising views A, B, and C

FIGS. 4 and 5 (Partial views comprising single top view)

A: Initial drive pulley for drive line (N) shown

B: Routing pulley for drive line (N) shown

C and D: Routing pulleys (moveable) for drive line (N) shown; mounted to shifter (V)

E: Drive spool driven by drive line (N) shown

F: Initial drive pulley for drive line not shown

G: Routing pulley for drive line not shown

K: Drive spool driven by drive line not shown

L: Frame

M: Frame crossmember

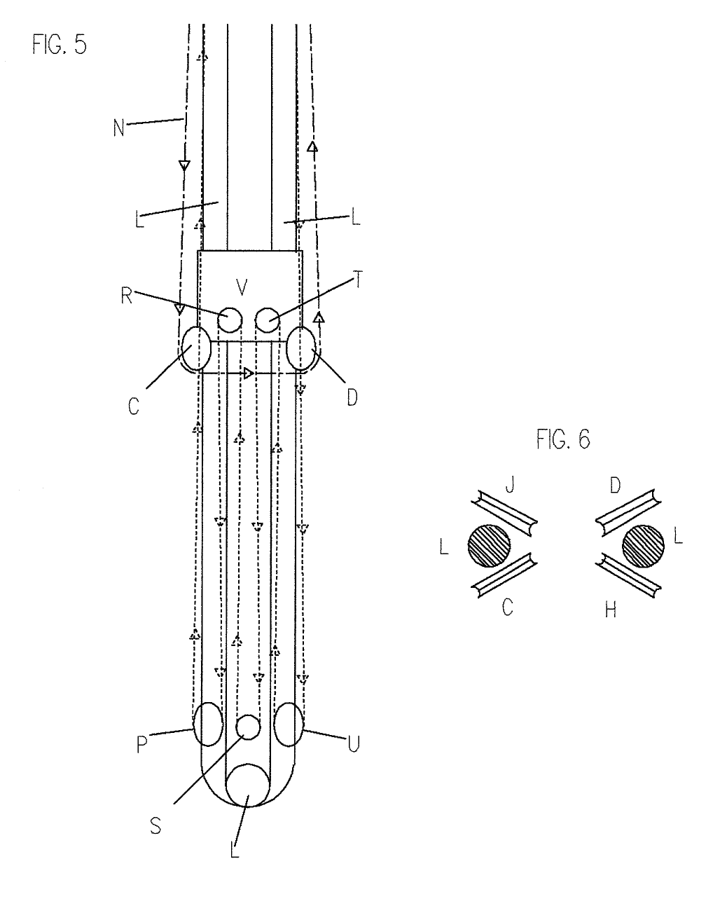

N: Drive line shown (Other drive line, as well as moveable pulleys H and J in FIG. 6. omitted from FIGS. 4 and 5 for clarity)

O: Rewind line

P, S, and U: Rewind-line routing pulleys mounted to front of frame

R and T: Rewind-line routing pulleys mounted to shifter

V: Shifter

FIG. 6 (end view, from front of frame, of shifter-mounted drive-line pulley location)

C and D: Moveable drive-line routing pulleys for drive line (N) shown in FIG. 5

H and J: Moveable drive-line routing pulleys for drive line not shown in FIG. 5

L: Frame

### DETAILED DESCRIPTION OF THE INVENTION

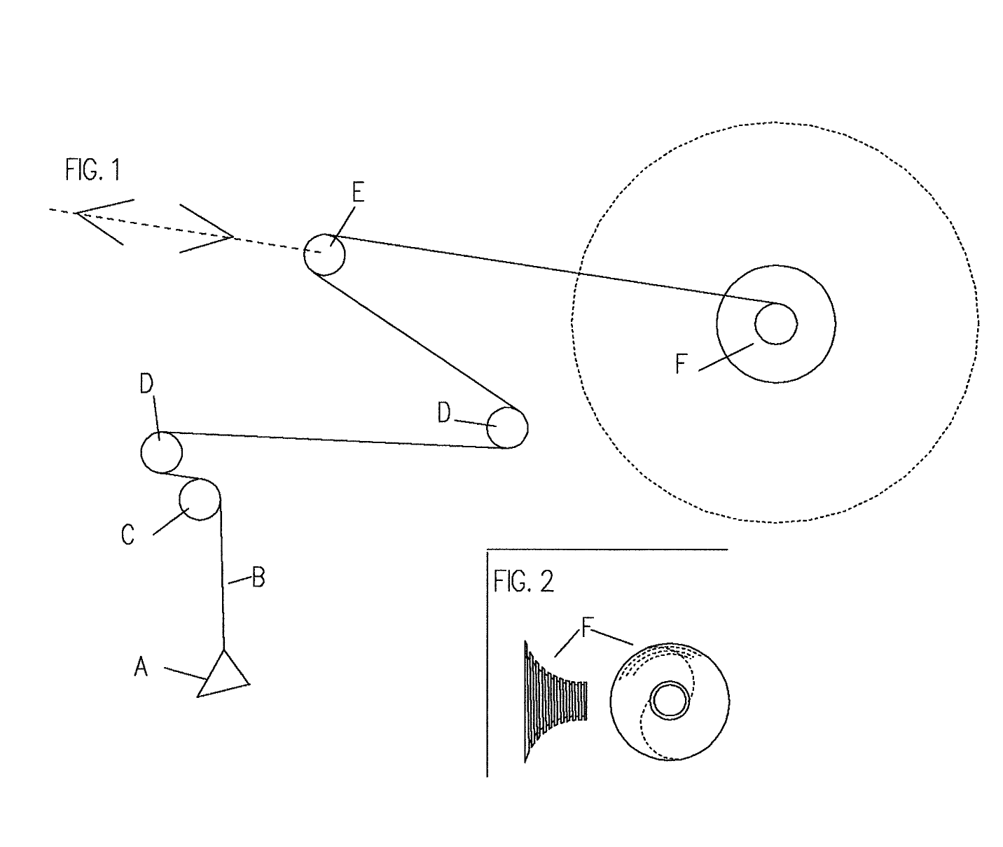

FIG. 1 is a schematic of the major components of the drive system. From the stirrup (A), the drive line (B) is pulled downward, first through the initial drive pulley (C), which is located so as to provide an unobstructed path for the operator's leg, then through routing pulley(s) (D) to moveable pulley(s) (E), and finally to drive spool (F), which drives the hub of the rear wheel.

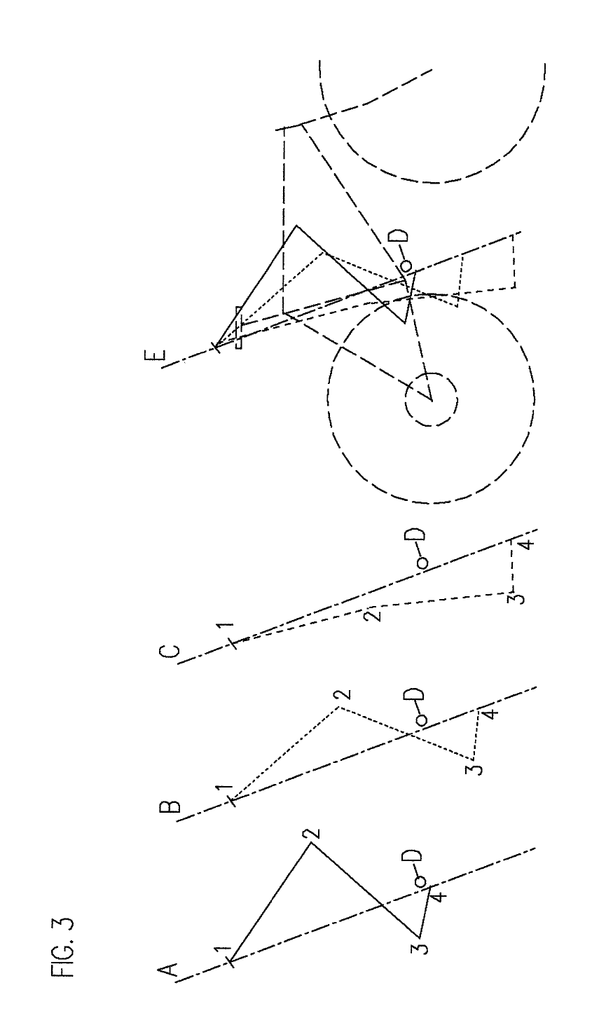

FIG. 2 illustrates the spiral cone configuration of the drive spool, which, in conjunction with the moveable pulley(s) (FIG. 1E), allows for drive-ratio variation.

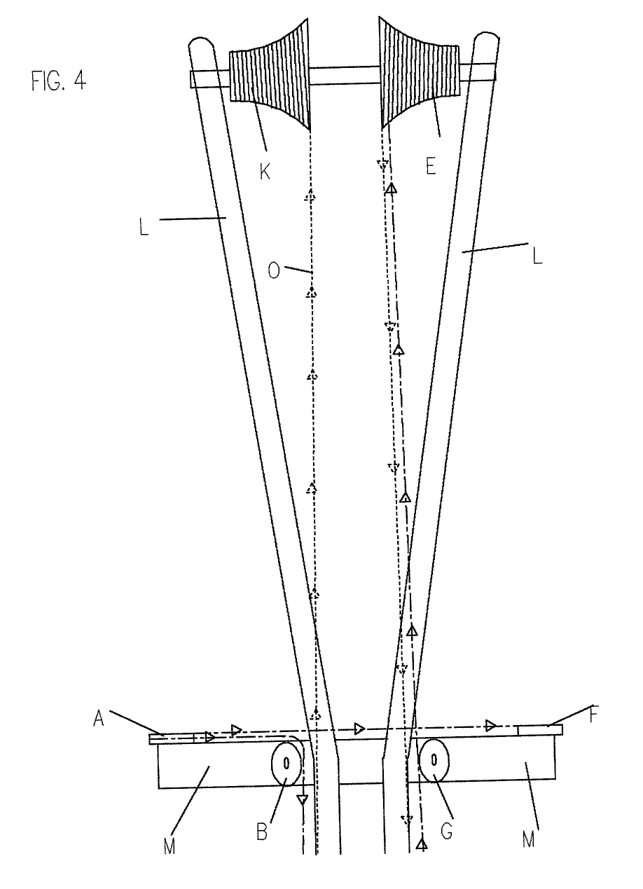

FIG. 3 is a schematic illustrating the action of the operator's leg when driving the system. In FIGS. 3A, B, and C, the leg is shown at three positions: A: fully retracted at top of stroke; B: at mid-point of stroke; and C: fully extended at bottom of stroke. Subordinate numbering in all three views (A, B, and C) refers as follows: 1: center of hip joint; 2: center of knee joint; 3: center of ankle joint; and 4: center of “ball” of foot. FIG. 3D shows the location of the initial drive pulley, which is critical both to establishing the desired path of travel for the leg and to providing clearance between itself and the shin portion of the leg. FIG. 3E incorporates FIGS. 3A, B, and C to demonstrate the action of the operator's leg when operating the system.

The path of travel (the line established in FIGS. 3A, B, and C by points 1 and 4) is actually determined by point 1 and by the point on the initial drive pulley D at which the drive line emerges therefrom toward the stirrup at point 4. This path will automatically be sought by the operator's leg as it is extended against the resistance provided by the work of driving the system; thus, deliberate control by the operator of the leg's path of travel is required only on the return, or retraction, stroke.

FIGS. 4 and 5 comprise a top-view schematic of the entire system as employed in the preferred embodiment, which is an upright bicycle. In addition to the elements already discussed, this figure also demonstrates the design and function of the system for rewinding of the drive spools. For the purpose of clarity, only one drive line is shown in these figures, this being the line N driving spool E from initial pulley A, which, along with initial pulley F and routing pulleys B and G, is mounted to frame crossmember M. An identical and separate drive line, not shown in the figures, drives spool K from initial pulley F in a manner identical to that of drive line N.

FIG. 6 is an end view of the positioning of the moveable drive-line routing pulleys (C and D for drive line N; H and J for drive line not shown) on the shifter (FIG. 5V). The mounting of rewind-system pulleys (FIGS. 5R and T) is not shown because, due to the much lower tension of the rewind system, the location of these pulleys is critical only in ensuring non-interference with the drive lines. Drive line N follows a diagonal path through the frame as it passes around pulleys C and D (routing pulley [FIG. 4B] aligns drive line N for proper entry into the shifter); emerging from the shifter at pulley D, it travels directly to drive spool (FIG. 4E), to whose small-diameter end it is anchored. The other drive line (not shown), which travels from initial pulley F, through routing pulley G, then through shifter pulleys H and J to drive spool K, is prevented from interfering with drive line N by positioning one diagonally-opposed pair of shift pulleys (e.g., H and J) slightly forward of the other pair (e.g., C and D).

This diagonal routing of the drive lines through the shifter and frame neutralizes lateral forces exerted on the shifter body and on the frame segment on which it slides. This important neutralizing balance is further ensured by (1) maintaining straightness in the entire frame segment shown as FIGS. 4 and 5L such that the shifter travels along a line which, if extended rearward, will intersect the center of the hub; (2) locating the drive-line routing pulleys on the shifter so as to align properly with the drive spools at the hub; and (3) aligning routing pulleys (FIGS. 4B and G) properly with the shifter.

Each drive line is anchored to its respective drive spool at the spool's small-diameter (app. 1¼″) end; at the drive-ratio setting illustrated in FIG. 4, it engages the whole of the spool's spiral groove, emerging at the large-diameter (app. 2½″) end. When the line is pulled downward by the stirrup, it will drive its spool at a relatively high drive-to-driven ratio, or what is normally referred to as a “low gear”. Each such downward stroke will rotate the spool approximately 1½ turns, so that only the large-diameter segment of the spool is actually being employed to drive the hub. When the shifter (FIG. 5V) is moved along the frame (FIG. 5L) in the direction away from the hub, some of the drive line will be unwound from each spool such that a downward stroke with the shifter in this forward position will drive the spool in “high gear”. Since there is no inherent limit to the number of locating positions possible for the shifter within its range of travel, this system provides infinite variability of drive ratio within its limits. Furthermore, since the diameter of the spool's spiral groove is not constant at any point, the drive ratio will decrease incrementally (toward a “higher gear”) during every downward stroke. Due to the fact that the strength of the operator's leg increases as it is extended, this phenomenon represents an added advantage to this system.

Rewinding of the drive lines onto the drive spools during the return stroke is accomplished by a separate rewinding line (FIG. 40). This single line, with its ends anchored to both drive spools at their large-diameter ends, uses the forward rotation of the spool being driven at any given moment to rewind the other spool. The line, routed from one spool to the other around the front of the frame, must also be routed through the shifter in the direction opposite to that of the drive lines in order to accommodate the simultaneous same-direction rotation of the spools during shifting. Furthermore, since both of the drive lines are rewound by one rewind line, the rewind line must be routed twice through the shifter in order to establish an equality of alteration of the effective length of the respective lines. Routing pulleys (FIGS. 5P, S, and U), which are located at the front of the frame, and moveable pulleys (FIGS. 5R and T), which are mounted to the shifter, accomplish the necessary routing.

The rewind line utilizes the same spiral groove in the drive spools as do the drive lines. Since the rewind line anchors to the end of each spool opposite to that at which the drive line is anchored, and since the action of the relative lines is opposed as well, no infringement occurs; the rewind line is never closer than a half-turn of the spool to either drive line.

A tensioner operating on the rewind line maintains tautness throughout not only the rewind system but both drive systems as well, due to the ability of the drive spools to rotate freely at all times in the rewinding direction. In the preferred embodiment, rewind pulleys (FIGS. 4P and U) are mounted to a spring-loaded swingarm which has an operational range sufficient not only for rewinding during normal system operation but also for simultaneous rewinding of both drive spools so that both drive lines will retract fully to the initial drive pulleys when the stirrups are disengaged from the drive lines. This swingarm is not depicted in the drawings because the specific location and design of the tensioner are not critical to the system's function and thus are not claimed by the inventor. Also not claimed is the specific design of the stirrup(s), which will likely be incorporated into a specially constructed shoe with a hook at the top to facilitate engagement of the shoe-stirrup unit with its drive line.

With the exception of the drive spools, all pulleys used are standard ball-bearing pulleys. The drive spools are preferably manufactured of aluminum and can be either machined or cast. They measure approximately 1½″ in width; their diameter ranges from approximately 1¼″ to 2½″; and their spiral groove, whose width is ⅛″, runs approximately ten circuits around them. They contain press-fitted one-way roller clutches which drive the rear-wheel hub. The drive line utilizes a woven dacron material which is manufactured and marketed for use as parachute brake and steering line. This line is flexible and non-stretch, is ⅛″ in thickness, and possesses a breaking strength of 700 lbs. The rewind line, which is subjected only to the tension placed upon it by the tensioner, utilizes woven fishing line. In the preferred embodiment as an upright bicycle, only the lower frame segment and the drive/rewind system itself present any variation from standard bicycle layout and construction.

1. I claim: the position of the initial drive pulleys (FIGS. 4A and F) so as to establish the desired path of travel (FIG. 3E) for the operator's legs as well as provide clearance between themselves and the shin portions of the operator's legs.

2. I claim: the combination of the conical spiral configuration of the drive spools (FIGS. 4E and K) with the moveable shifter-mounted pulleys (FIGS. 6C, D, H, and J), which provides variability of the drive ratio.

3. I claim: the diagonally-opposed positioning of the moveable shifter-mounted pulleys (FIGS. 6C, D, H, and J) on the shifter (FIG. 5V), which, with the spaced-twin-tube design of the frame (FIG. 6L), balances and thus neutralizes lateral forces placed on the shifter by the drive lines.

4. I claim: the rewind system for the above drive system, consisting of a separate line, properly routed and equipped with a tensioner, by means of which each of the drive spools (FIGS. 4E and K) rewinds the other during operation of the drive system.
